(19) United States
(12) Patent Application Publication
(10) Pub. No.: US 2026/0245022 A1
(43) Pub. Date: Aug. 20, 2026

(54) PowerRank: System and Method for Verified Influence Scoring

(71) Applicant: George William Bickerstaff, III, Greenwich, CT (US)

(72) Inventor: George William Bickerstaff, III, Greenwich, CT (US)

(21) Appl. No.: 19/302,048

(22) Filed: Aug. 17, 2025

(51) Int. Cl. G06Q 10/0639; G06Q 30/0201

(52) U.S. Cl. CPC G06Q 10/06393; G06Q 30/02013

(57) ABSTRACT

A computer-implemented system and method generate verifiable influence scores using authenticated multi-source data. Records are validated through consensus corroboration, processed through category-based scoring and adaptive normalization, and transformed into percentile rankings. The system provides transparent provenance, benchmarking, and secure access, enabling auditable and manipulation-resistant influence measurement across multiple domains.

### CROSS-REFERENCE TO RELATED APPLICATIONS

This application claims the benefit of U.S. Provisional Patent Application No. 63/123,456, filed Jul. 15, 2025, the entirety of which is incorporated herein by reference.

### TECHNICAL FIELD

The present invention relates to computer-implemented data analytics systems.

More particularly, the invention relates to systems and methods for generating, validating, normalizing, and presenting verifiable influence scores across professional, academic, governmental, and commercial domains.

### DEFINITIONS

Anomaly Filtering means automated exclusion or down-weighting of records deviating from statistically or logically expected bounds.

Baseline Distribution means a reference population distribution used to normalize composite scores into percentile rankings.

Consensus Validation means corroboration of a data record across at least two independent authenticated sources.

Influence Score means a normalized percentile-based numerical representation of relative influence within a defined peer population.

Normalization means transformation of a composite raw score into a percentile ranking using quantile-based statistical mapping.

Peer Group means a comparison cohort defined by shared attributes including sector, geography, role, or scale.

Provenance Hash means a cryptographic digest generated from validated records to preserve lineage and integrity.

Scoring Engine means a computational module that generates category sub-scores and fuses them into a composite raw score.

Sub-Score means a category-specific numerical value derived from validated records relating to a defined influence dimension.

Unified Schema means a standardized data structure into which heterogeneous records are normalized for processing.

### BACKGROUND

Existing influence scoring systems rely primarily on single-source or self-reported data and are therefore susceptible to manipulation, inflation, and opacity.

Prior systems fail to corroborate records across independent repositories and do not provide auditable provenance or lineage.

Static normalization approaches further degrade score reliability as peer populations evolve over time.

There remains a need for a transparent, verifiable, and manipulation-resistant influence scoring system that adapts dynamically while remaining auditable.

### SUMMARY (BROADER DESCRIPTION)

The present invention provides a computer-implemented framework for generating percentile-based influence scores using authenticated, multi-source data that is corroborated prior to scoring.

The system integrates consensus validation, integrity controls, category-based scoring, adaptive normalization, and benchmarking into a unified architecture capable of operating across diverse domains, including business leadership assessment, academic evaluation, professional credentialing, and institutional benchmarking.

By combining multi-source verification, deterministic scoring, dynamic percentile normalization, and cryptographic provenance, the invention produces influence scores that are auditable, comparable across populations, resistant to manipulation, and suitable for integration into automated decision-support systems.

### BRIEF DESCRIPTION OF THE DRAWINGS

FIG. 1—System Architecture

FIG. 2—Scoring Engine

FIG. 3—Normalization Pipeline

FIG. 4—Output Interface

FIG. 5—Peer Benchmarking

### DETAILED DESCRIPTION

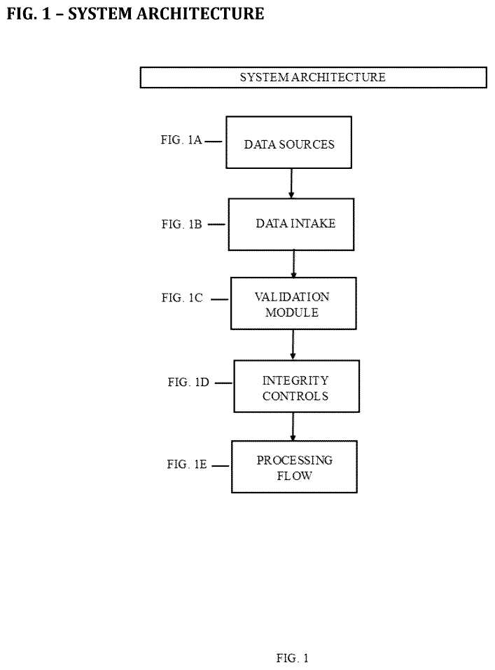

### FIG. 1—System Architecture

FIG. 1(a)—Data Sources illustrates multiple authenticated repositories supplying records to the system, including regulatory filings, academic databases, and professional networks. Each source provides independently verifiable data relevant to one or more influence dimensions. Independent sourcing enables corroboration prior to any scoring operation.

FIG. 1(b)—Data Intake illustrates a data intake module that organizes received records into a unified schema. Structural harmonization allows heterogeneous records to be processed consistently without altering underlying content. This standardization supports downstream validation and scoring.

FIG. 1(c)—Validation Module illustrates a consensus validation module that corroborates records across independent sources. Records failing corroboration may be excluded or down-weighted based on system configuration. Validation occurs before scoring to prevent unverified data from influencing results.

FIG. 1(d)—Integrity Controls illustrates optional integrity modules including provenance hashing, anomaly filtering, and privacy safeguards. Provenance hashing preserves record lineage, anomaly filtering detects implausible data, and privacy safeguards enforce regulatory compliance. These controls operate deterministically and independently of scoring logic.

FIG. 1(e)—Processing Flow illustrates the transfer of validated records to scoring, normalization, and output modules. Only validated records propagate through the system. This enforced separation ensures score integrity.

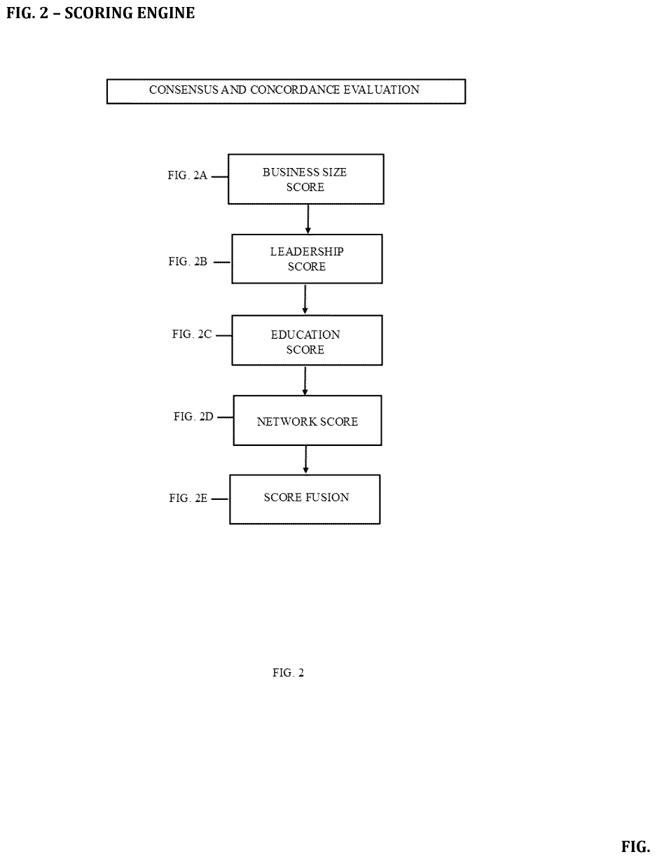

### FIG. 2—Scoring Engine

FIG. 2(a)—Business Size Score illustrates computation of organizational scale using validated quantitative indicators such as revenue ranges, employee counts, or market capitalization tiers. Scores are normalized within category bounds to ensure comparability. Only corroborated metrics contribute to the sub-score.

FIG. 2(b)—Leadership Score illustrates evaluation of ranked leadership roles using role hierarchy, tenure duration, and organizational context. Leadership records are validated prior to scoring. The sub-score reflects both position level and verified duration.

FIG. 2(c)—Education Score illustrates credential-based scoring derived from verified academic records. Degree level, institutional accreditation, and recognized ranking tiers may be considered. Unverified or honorary credentials may be excluded or weighted differently.

FIG. 2(d)—Network Score illustrates evaluation of verified professional connections. Only authenticated and corroborated connections are counted. Artificial, automated, or unverified links are excluded.

FIG. 2(e)—Score Fusion illustrates application of category weights and fusion of sub-scores into a composite raw score. Weights may be fixed or dynamically adjusted based on entity type or peer group. The resulting composite raw score serves as input to normalization.

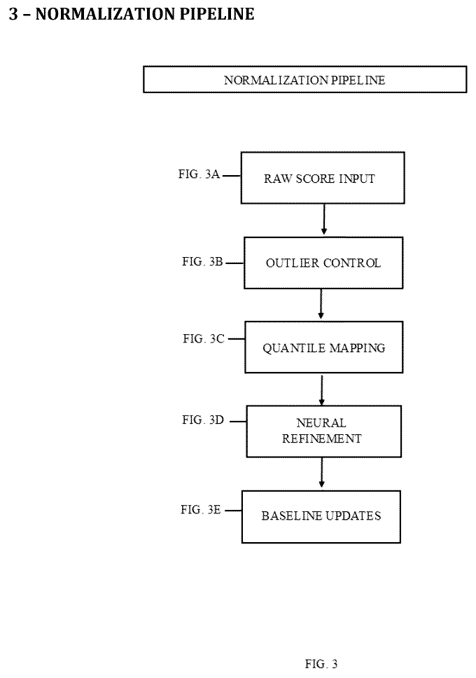

### FIG. 3—Normalization Pipeline

FIG. 3(a)—Raw Score Input illustrates receipt of the composite raw score prior to normalization. The raw score reflects weighted aggregation but not relative standing. No percentile mapping has yet occurred.

FIG. 3(b)—Outlier Control illustrates optional moderation of extreme values using rule-based or statistical thresholds. This step preserves stability of the distribution. Outlier handling does not alter validated underlying data.

FIG. 3(c)—Quantile Mapping illustrates transformation of raw scores into percentile rankings relative to a baseline distribution. Quantile mapping serves as the primary normalization mechanism. This enables cross-group comparability.

FIG. 3(d)—Neural Refinement illustrates optional application of a learned non-linear transformation trained on historical peer distributions. This refinement adapts normalization as populations evolve. The step is supplemental and does not replace quantile mapping.

FIG. 3(e)—Baseline Updates illustrates dynamic updating of baseline distributions over time. Updates preserve historical comparability through versioning. Percentile consistency is maintained across reporting periods.

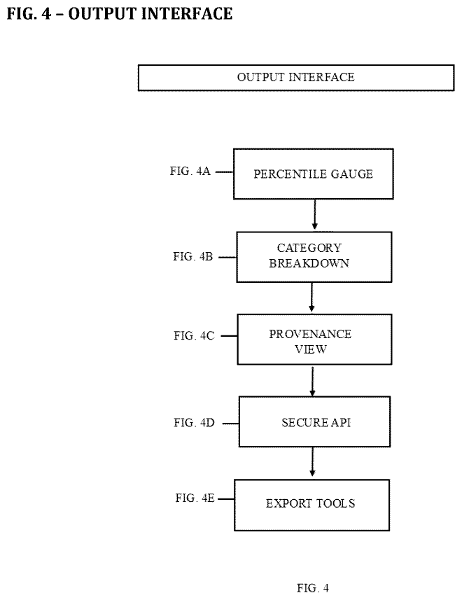

### FIG. 4—Output Interface

FIG. 4(a)—Percentile Gauge illustrates a composite visualization of an entity's relative influence ranking. The gauge communicates percentile standing clearly and intuitively. Values are normalized within the defined peer group.

FIG. 4(b)—Category Breakdown illustrates visualization of individual sub-score contributions. Users may inspect how each category influences the composite score. This transparency supports auditability.

FIG. 4(c)—Provenance View illustrates lineage tracing from the influence score back to validated records. Cryptographic hashes support verification of data integrity. This enables independent audit and review.

FIG. 4(d)—Secure API illustrates authenticated programmatic access to scores and metadata. Machine-readable output supports integration with external systems. Access controls enforce security policies.

FIG. 4(e)—Export Tools illustrates export and integration mechanisms. Results may be transmitted to third-party systems while preserving provenance. Data formats may include structured files or API payloads.

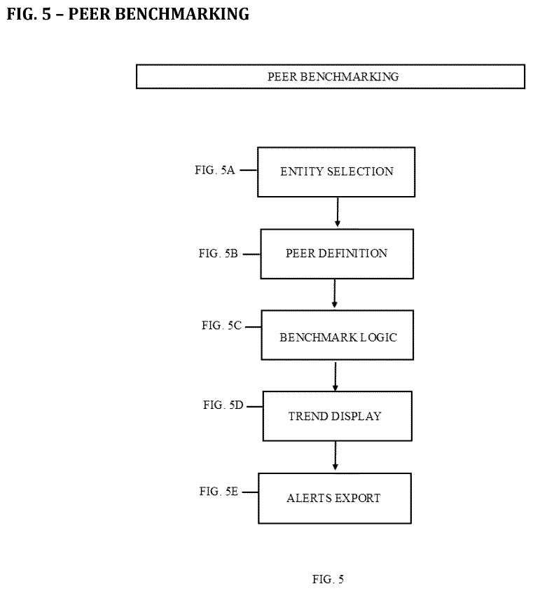

### FIG. 5—Peer Benchmarking

FIG. 5(a)—Entity Selection illustrates selection of an entity for benchmarking analysis. Contextual attributes define the evaluation frame. Selection initiates comparative processing.

FIG. 5(b)—Peer Definition illustrates formation of peer groups based on shared attributes. Peer definitions may be sector-, geography-, or scale-based. Definitions are versioned for consistency.

FIG. 5(c)—Benchmark Logic illustrates comparative percentile computation across peer groups. Relative positioning is calculated deterministically. Results may include category-level comparisons.

FIG. 5(d)—Trend Display illustrates time-series visualization of percentile movement. Changes in relative influence over time are observable. Stability and volatility may be assessed.

FIG. 5(e)—Alerts Export illustrates notification and data delivery mechanisms. Threshold changes may trigger alerts. Results may be exported or integrated externally.

### Enablement Examples

### Example 1—Executive Benchmarking

An executive's influence score is generated by validating leadership roles across regulatory filings and professional databases, scoring business size, leadership position, education, and network dimensions, and normalizing the composite score against a peer group of similarly sized organizations. The resulting percentile ranking is displayed with provenance links. Benchmarking reveals relative standing within the executive's industry sector.

### Example 2—Academic Evaluation

An academic institution evaluates influence by validating faculty credentials across publication databases and accreditation records, computing sub-scores for education, leadership, and professional networks, and normalizing scores against peer institutions. Percentile rankings are tracked over time using baseline updates. Provenance views enable audit of underlying records.

1. An electronic system for producing a percentile-based influence score for an entity, comprising:
a plurality of authenticated data sources supplying records relating to business size, leadership positions, educational achievement, and professional networks;
a data intake module configured to organize said records into a unified schema;
a consensus validation module configured to corroborate each record across at least two independent data sources, the consensus validation module further comprising:
a provenance hashing unit that generates cryptographic hashes of validated records to preserve lineage,
a standardization unit that harmonizes formats across records,
an anomaly filtering unit that rejects implausible records, and
a privacy safeguard unit that enforces compliance with data protection requirements;
a scoring engine configured to generate category sub-scores, apply category weights, and combine the sub-scores into a composite raw score, the scoring engine comprising:
a business size sub-score calculator,
a leadership positions sub-score calculator,
an educational achievement sub-score calculator,
a network size sub-score calculator,
a weighting module, and
a fusion module;
a normalization module configured to transform the composite raw score into a percentile-based score, the normalization module comprising:
an outlier adjustment unit,
a quantile mapping unit,
an optional quantile neural network unit trained on historical peer distributions, and
a baseline update unit configured to adjust percentile distributions dynamically to maintain cross-group comparability;
an output interface configured to present the percentile-based score through:
a composite score gauge,
category breakdown charts,
a provenance lineage view,
a secure programmatic access endpoint,
interactive features, and
results delivery options; and
a peer benchmarking module configured to perform comparative analysis, the peer benchmarking module comprising:
a user input entity selector,
a peer group selection unit,
a benchmarking processor,
a line chart output,
a heatmap output, and
export and API access.

2. A computer-implemented method for generating a percentile-based influence score for an entity, comprising the steps of:
receiving records from multiple authenticated data sources;
validating the records through consensus corroboration across at least two independent sources;
hashing validated records with a provenance hashing unit, standardizing formats, filtering anomalies, and applying privacy safeguards;
computing category sub-scores for business size, leadership positions, educational achievement, and network size using a scoring engine;
applying weights and fusing the sub-scores into a composite raw score;
normalizing the composite raw score by applying outlier adjustment, quantile mapping, and optionally a quantile neural network;
updating percentile baselines dynamically to maintain cross-group comparability; and
presenting the normalized percentile score through an output interface including a composite display, category breakdowns, provenance lineage views, secure programmatic interfaces, interactive features, and benchmarking outputs.

3. A non-transitory computer-readable medium storing instructions that, when executed by one or more processors, cause the processors to perform the method of claim 2.

4. The system of claim 1, wherein the consensus validation module excludes unverified records and down-weights stale records.

5. The system of claim 1, wherein the anomaly filtering unit applies z-score analysis, interquartile range analysis, or rule-based rejection thresholds to identify and reject implausible records.

6. The system of claim 1, wherein the standardization unit applies text normalization, unit conversion, or ontology alignment to harmonize records across data sources.

7. The system of claim 1, wherein the privacy safeguard unit employs anonymization, tokenization, or federated learning to preserve compliance with data protection requirements.

8. The system of claim 1, wherein the baseline update unit employs privacy-preserving distributed methods to update percentile distributions.

9. The system of claim 1, wherein the quantile neural network unit is trained on historical peer distributions for adaptive normalization.

10. The system of claim 1, wherein the output interface integrates with compliance dashboards or third-party benchmarking systems.

11. The system of claim 1, wherein the export and API access unit delivers scores and provenance metadata in a blockchain-anchored format.

12. The system of claim 1, wherein the peer benchmarking module records peer group definitions and baseline version identifiers.

13. The method of claim 2, further comprising recording provenance lineage for each validated record.

14. The system of claim 1, wherein the weighting module dynamically adjusts category weights based on entity type, sector classification, or temporal factors.

15. The system of claim 1, wherein the educational achievement sub-score calculator assigns weighted values to degree levels, institutional rankings, and accreditation tiers.

16. The system of claim 1, wherein the leadership positions sub-score calculator incorporates organization size, role hierarchy, and tenure duration.

17. The system of claim 1, wherein the business size sub-score calculator integrates financial metrics, employee headcount, or market capitalization.

18. The system of claim 1, wherein the peer benchmarking module generates time-series comparisons to track percentile score evolution across reporting periods.

19. The system of claim 1, wherein the interactive features of the output interface provide drill-down lineage of each record used in the score, with user-selectable peer groups.

20. The method of claim 2, further comprising issuing alerts when an entity's percentile rank changes by more than a predefined threshold across reporting periods.
